(19) United States
(12) Patent Application Publication
(10) Pub. No.: US 2024/0199016 A1
(43) Pub. Date: Jun. 20, 2024

(54) METHOD FOR CONTROLLING A VEHICLE, CONTROL DEVICE, COMPUTER PROGRAM PRODUCT AND VEHICLE

(71) Applicant: HELLA GmbH & Co. KGaA, Lippstadt (DE)

(72) Inventor: Kay TALMI, Berlin (DE)

(73) Assignee: HELLA GmbH & Co. KGaA, Lippstadt (DE)

(21) Appl. No.: 18/406,761

(22) Filed: Jan. 8, 2024

Related U.S. Application Data
(63) Continuation of application No. PCT/EP2022/065969, filed on Jun. 13, 2022.

(30) Foreign Application Priority Data
Jul. 6, 2021 (DE) 10 2021 117 424.4

(51) Int. Cl. B60W 30/14

(52) U.S. Cl. CPC B60W 30/146; B60W 2555/60; B60W 2556/45; B60W 2556/50; B60W 2720/10

(57) ABSTRACT

A method for controlling a vehicle including at least one sensor and at least one actuator, and a control device as well as a processing unit. The particular sensor provides sensor values to the control device. An input device provides an input signal to the control device. The control device provides at least one output signal to the actuator. The output signal being determined and provided based on the input signal and the at least one sensor signal, taking an ontology into account, wherein it is decided, based on the ontology, whether an output signal is provided, if at all, to an actuator, or to which actuator the output signal is provided, and wherein the ontology is based on traffic regulations. A control device and a computer program product for carrying out the method are also provided.

This nonprovisional application is a continuation of International Application No. PCT/EP2022/065969, which was filed on Jun. 13, 2022, and which claims priority to German Patent Application No. 10 2021 117 424.4, which was filed in Germany on Jul. 6, 2021, and which are both herein incorporated by reference.

### BACKGROUND OF THE INVENTION

### Field of the Invention

The invention relates to a method for controlling a vehicle, a control device, a computer program product, and a vehicle that includes such a control device.

### Description of the Background Art

Today's vehicles moving in street traffic or rail traffic are subject to numerous regulations. For example, in places there are limitations on a maximum speed. These must be heeded by a person driving the vehicle, or in the case of an autonomously driving vehicle, by a vehicle control.

Although there are already vehicle controls (referred to here as a control device) which, based on traffic sign recognition, provide information to the person driving the vehicle, these approaches are usually isolated solutions for individual areas such as traffic sign recognition.

### SUMMARY OF THE INVENTION

It is therefore an object of the invention to provide a universally applicable approach for assisting the control of a vehicle.

In an example, a method is used to control a vehicle, advantageously a motor vehicle or a rail vehicle, the vehicle including at least one sensor and at least one actuator, and a control device as well as a processing unit, wherein the particular sensor provides sensor values to the control device, wherein an input device provides an input signal to the control device, wherein the control device provides at least one output signal to the actuator, wherein the output signal is determined and provided based on the input signal and the at least one sensor signal, taking an ontology into account, wherein it is decided, based on the ontology, whether an output signal is provided, or to which actuator the output signal is provided, and wherein the ontology is based on traffic regulations or traffic laws.

The ontology can be advantageously designed as a decision logic. For an input signal, based on the ontology it is advantageously decided whether an output signal is provided (if at all) to the corresponding actuator or to which actuator an output signal is provided.

Optionally, based on the ontology it may be decided whether a warning signal is output to the driver of the vehicle.

The ontology advantageously includes regulations that influence a decision logic.

The ontology is advantageously stored in a memory, from which it may be queried. The memory is advantageously integrated into the control device. The control device advantageously includes the processing unit, the processing unit being configured to execute the computer program product, wherein the computer program product includes the ontology. The ontology is advantageously installed, as part of a computer program product, on a processing unit of the vehicle and executable on same.

The ontology may be designed as a neural network or some other trainable algorithm, wherein during the learning and/or the training, the particular local or country specific traffic regulations or traffic laws are integrated.

Traffic regulations are for example, appropriate limitations, permissions, or prohibitions of the particular traffic laws or traffic regulations. The traffic regulations are preferably developed in such a way that a linkage of one or more sensor values and an input signal is formed as allowed, not allowed, or conditionally allowed.

Based on the ontology, a further sensor value may advantageously be determined in order to provide a decision for the output signal in question.

The vehicle is advantageously a participant in the traffic that is regulated by the traffic regulations. For example, for a rail vehicle the regulations for rail traffic may also be provided as traffic regulations.

The ontology advantageously takes into account the particular location of the vehicle and/or the speed of the vehicle.

A first example is used for better understanding of the invention:

If the input device, for example, of a high beam switch, is actuated, the input signal is provided to the control device. The control device checks, with the aid of the ontology, the permission to activate a high beam by the actuator, in the present case of the light control or of the headlight. The check takes place based on traffic regulations. According to the ontology, which is advantageously based on the traffic regulations valid at the time, the stipulation is communicated to the control device that activation of the high beam outside of urban areas is allowed. The location is established and determined only by use of a sensor, for example a GPS receiver, as to whether the vehicle is in an urban area. Alternatively or additionally, by use of a vehicle camera or a radar module it may be determined whether the vehicle is in an urban area. If the vehicle is in an urban area, within the scope of the invention there is an option that the activation of the high beam does not take place, or a warning message is initially output.

If the warning message can be output, this may take place as a signal to the vehicle driver.

By use of the invention, compliance with traffic regulations by the vehicle may be ensured, and traffic safety may thus be significantly increased.

The method can be advantageously expandable in such a way that in the event of a negative decision by the ontology, activation of the actuator does not take place and/or an appropriate warning signal is output.

The control device may be advantageously the controller of the vehicle. The control device is preferably designed as a microcomputer, the ontology being storable on a memory. The ontology is preferably adaptable to traffic regulations that are valid at the time.

An ontology can be advantageously designed as an if-then decision characteristic. In the case of such a decision characteristic, for an input signal (if) the output (then) takes place, based on the ontology. The input and the output preferably take place by use of the control device.

The ontology can be advantageously designed to be representable, installable, or executable in a formal language such as a Unified Modeling Language (UML).

The ontology can be advantageously adaptable to possible changes in the traffic regulations via updates.

The ontology is storable in a memory in the vehicle.

The ontology can be designed as a decision logic with an optional test logic. The ontology can be stored on the memory as a data structure. The ontology is advantageously stored in the memory as part of a computer program product.

The memory can be integrated into the control device. Alternatively or additionally, the memory is designed as a central memory of the vehicle.

As the result of storing the ontology in a memory of the vehicle, the method described here may take place even if there is no data link from the vehicle.

The ontology can be stored, at least in part, on a decentralized server, the control device being at least temporarily data-linked to the central server.

The data linkage advantageously takes place via a technical data link.

A data link from the vehicle and the decentralized server may be formed here by a mobile radio connection or some other technical data link such as Wi-Fi or a cable-wired data link. The decentralized server may be designed as a data cloud or as an internet server.

The particular ontology may thus be adapted to new traffic regulations in a particularly simple manner.

The ontology can also include the traffic regulations or laws.

The ontology can include the traffic regulations of the country in which the vehicle is present at the time. When the vehicle crosses over into another country, this may be determined by use of GPS data, for example, and in such a case the appropriate ontology is provided for the control device.

The adaptation of the ontology may be simplified by not replacing traffic regulations that are at least essentially the same.

A plurality of ontologies may be storable on a memory in the vehicle, the particular ontology for a country in question being provided. The particular ontology is used to assist the control device of the vehicle in the country in which the vehicle is present. Alternatively, an ontology may include or take into account traffic regulations for a plurality of countries.

Ontologies that are available for the particular countries are advantageously used in a combined ontology that provides the output signals corresponding to the location of the vehicle.

Thus, it may be ensured that the ontology heeds the particular valid traffic regulations during operation of the vehicle.

The ontology in each case can include or is based on the traffic regulations of a particular region or a country, in particular of a country or a state, that are in effect. The particular traffic regulations are advantageously selected based on the particular location of the vehicle.

An image of the surroundings of the vehicle may optionally be used for selecting the ontology or a portion of a combined ontology. By recognition of country- typical traffic signs, the location of the vehicle may be determined or the GPS sensor data may be checked.

In particular, the use of a GPS sensor for selecting the particular ontology by determining the location of the vehicle is a very reliable method. By taking into account in each case the ontology that is valid in the particular country, the traffic safety after the vehicle crosses a national boundary is advantageously improved.

It can be decided, based on the ontology, whether or not the particular actuator carries out an action by use of the control device.

An example of such can correspond to the example discussed above.

In the event that an action is not carried out, a warning signal may be output. After the warning signal, the action by the actuator in question may still be carried out, and the operating principle of the ontology may be ignored by reactuating the input device.

Such a warning signal may be the blinking of a warning light or an acoustic signal that notifies the driver of the vehicle of his/her action that is violating a traffic regulation.

As such, an inattentive driver may advantageously be notified of his/her error, thus further contributing to increased traffic safety. Moreover, the driver may advantageously be instructed, and thus trained, with regard to the particular valid traffic regulations.

However, if compliance with the particular traffic regulations is not advisable in the view of the driver, the driver may advantageously ignore the ontology.

It can be decided, based on the ontology, whether an output signal for a first actuator and/or an output signal for a second actuator is provided, based on an input signal.

A decision concerning which actuator carries out which action can be advantageously stored in the ontology. For example, if the accelerator pedal is activated and an acceleration is thus provided, in congested traffic a lane change is instructed as the action instead of the acceleration.

In a further example, if a rear fog light is activated in the absence of fog, it is possible for only the light intensity of the taillight to be increased, provided that a vehicle camera does not detect significant fog.

By carrying out an action that is different from that of the driver of the vehicle, based on sensor signals it is possible to ensure improved traffic management.

A sensor for providing GPS data can be provided at the control device.

Such a sensor can also be referred to as a GPS sensor, and provides the location of the vehicle to the control device, advantageously as a function of time.

Based on the location of the vehicle, for example the maximum allowable speed inside or outside a municipality may be determined, based on the ontology. The speed of the vehicle may be reduced, for example by use of an actuator, by comparing the allowable speed to the speed of the vehicle.

By determining the location of the vehicle, for example a maximum speed or a right-of-way at the location may be taken into account by use of the control device.

The ontology can be present in the form of a decision logic or a formal language, for example UML code.

The ontology can be designed as decision logic, in particular as if-then decision logic. By use of a formal language or such a decision logic, the ontology can be programmable in a particularly simple manner, and may easily map the traffic regulations.

The control device, in particular for controlling a vehicle, can comprise at least one input for at least oce sensor signal of a sensor, at least one input for at least one input signal of an input device, at least one output for at least one output signal for an actuator, and a processing unit for storing the ontology, wherein the processing unit is designed to check the input signal based on an ontology, wherein the check is provided based on at least one sensor signal, and wherein the control device is provided to supply an output signal to the particular actuator, the output signal being suppliable based on the check of the input signal, using the ontology, taking into account the least one sensor signal.

The control device can be designed as a central control device of the vehicle. The ontology can be part of a neural network, the neural network being designed and provided for controlling the vehicle.

The check advantageously takes place based on the specifications by the traffic regulations, the particular traffic regulation indicating whether an action of the actuator in question is allowed, advisable, or prohibited. In a first case, the action of the particular actuator is allowed or permitted according to the traffic regulations. In the first case, the control device provides an output signal to the actuator in question.

In a second case, the action of the actuator in question is not allowed or is prohibited according to the traffic regulations. In this case, the control device advantageously does not provide an output signal to the particular/corresponding actuator.

The control device can be designed as a microcomputer or as a microcontroller, the ontology being advantageously stored in a memory of the control device.

The control device can include inputs for connection to the particular sensors. It is also advantageous that the control device includes at least one output for at least one actuator, the actuator being advantageously provided for controlling the vehicle itself.

By use of the embodiment of the invention in the form of a control device, an existing vehicle may also be easily equipped with a new control device, and thus provided with the new functions described above.

The ontology may include traffic regulations or traffic laws.

The ontology may provide the traffic regulations in the form of if-then rules or other permissions or nonpermissions.

The particular ontology can be designed at least as part of a neural network, the neural network having been trained or taught taking the traffic regulations into account.

Particularly reliable vehicle driving in traffic may be ensured in the control of a vehicle by storing the traffic regulations in an ontology.

The processing unit can include a memory, the memory being designed for at least partial storage of the ontology.

Storage of the ontology can take place in a memory of the processing device and/or the memory of the control device of the vehicle. Rapid and reliable access by the processing unit and/or the control device may take place due to storing in this type of memory.

The control device can further include a technical data link to a decentralized server, the control device or the decentralized server being configured to provide an ontology.

Due to storing, preferably regularly, the ontology in the particular vehicle, changes in the traffic regulations may also advantageously be taken into account in the ontology.

The technical data link is advantageously designed as a wireless technical data link such as a 3G, 4G, or 5G data link. Alternatively, for an electrically operated vehicle, transfer of data may take place with the aid of a charging station, the charging station providing the ontology for the particular vehicle. The particular ontology may be transferred via a network connection or by modulating the charging current with a data signal.

The computer program product is designed for installation and execution on a processing unit, the computer program product being suited and provided for carrying out a method according to the above description.

The computer program product can be installed and executable on the processing unit and/or the control device. The computer program product is advantageously transferable into a working memory of the processing unit or of the control device and executable from there. The control device may be designed to carry out the method according to the above description when the computer program product is executed.

The computer program product can include the ontology, the ontology being designed, for example, as a module for decision-making for the linking of input signals and output signals.

In addition, the computer program product can include at least one input interface for the particular sensor signal and/or for the particular input signal. It is also advantageous that the computer program product includes at least one interface for providing the output signals. The output signals are advantageously used to activate the particular actuator.

The computer program can be designed so that it is installable on the processing unit of the control device of the vehicle and executable there.

The computer program product for carrying out the method can be loaded into a working memory of the processing unit and executed from there.

The invention may be integrated in a particularly simple manner as a result of the embodiment of the invention as a computer program product.

The vehicle, in particular a motor vehicle or rail vehicle, includes a control device according to the above description.

The vehicle can be an electrically driven vehicle or an at least temporarily electrically driven vehicle.

Furthermore, the vehicle is advantageously designed, in part, as a self- driving vehicle (in the sense of autonomous driving).

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a vehicle that includes an example of a control device;

FIG. 2 shows an example of the operating principle of an ontology;

FIG. 3 shows another example of the operating principle of an ontology; and

FIG. 4 shows a control device with a decentralized server.

### DETAILED DESCRIPTION

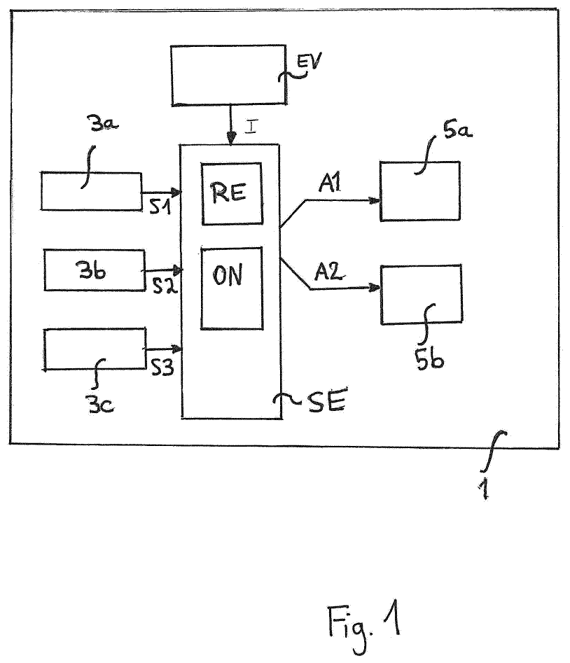

FIG. 1 shows a vehicle 1 that includes an example of a control device SE. The control device SE includes a processing unit RE and an ontology. The ontology ON is preferably stored in a memory 9 that is associated with the processing unit RE. The control device SE has an input for an input signal I of an input device EV. In addition, the control device SE has inputs for sensor signals S1, S2, S3, the sensor signals S1, S2, S3 being provided by sensors 3a, 3b, 3c, respectively, that are connected to the control device.

The control device also includes outputs for output signals A1, A2, the output signals A1, A2 being providable to actuators 5a, 5b, respectively. The control device SE may be designed as a microcontroller. Terminals of the particular vehicle bus, for example a CAN bus, are advantageously used as inputs or outputs.

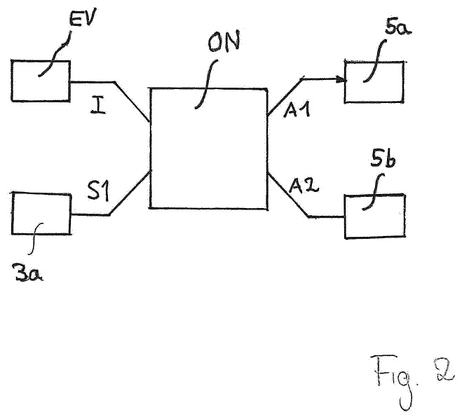

FIG. 2 shows an example of the operating principle of the ontology ON. An input signal I and at least one sensor signal S1 (for example, from a first sensor 3a in the present case) are provided to the ontology ON. The ontology ON is configured to decide, based on the input signal I and advantageously according to the at least one sensor signal S1, for which actuator 5a an output signal A1 is provided. In other words, the ontology ON is used to decide which actuator 5a (for example, another/different actuator 5b, 5c could also be selected) for the particular input signal I is to carry out an action. The ontology ON advantageously decides based on the sensor signal S1 and the stored traffic regulations.

The traffic regulations may be provided as traffic regulations associated with the vehicle. For a road vehicle, the traffic regulations or traffic laws are advantageously stored in the ontology ON. The ontology ON may also be designed as a trainable algorithm, the trainable algorithm having been trained to heed the particular valid traffic regulations. A trainable algorithm is preferably designed as a decision logic or as a neural network.

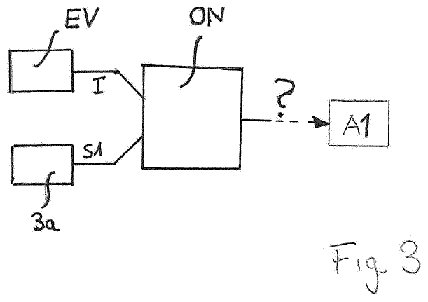

FIG. 3 shows another example of the operating principle of an ontology ON. As described above, the ontology ON is used for a decision regarding providing an output signal A1 for an actuator 5a, based on an input signal I and optionally an input sensor signal S1. The operating principle shown in FIG. 3 involves the decision of the ontology ON whether (or not) to provide an output signal A1 for an actuator 5a. The decision is symbolized by a question mark. Here as well, the ontology ON advantageously decides, based on the existing traffic regulations, whether an action of the particular actuator is allowed/permitted under the traffic regulations.

If the action is allowed, the output signal A1, A2 is provided in accordance with the ontology ON. If the action is not allowed or permitted according to the ontology ON, a warning signal may be provided by the control device SE. In such a case, the driver may “overrule” the ontology ON, for example by reactuating the input device, and the action is carried out by the particular actuator 5a, 5b despite the traffic regulations stored or taken into account in the ontology ON.

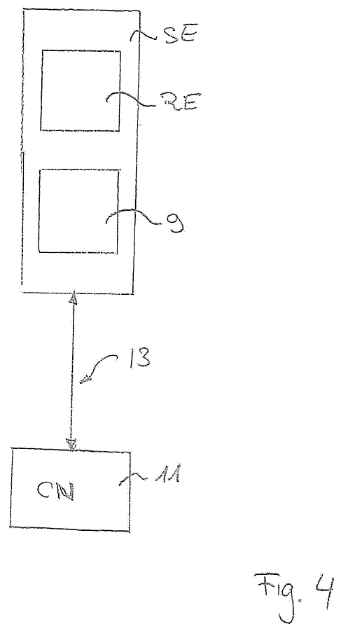

FIG. 4 shows a control device SE with a decentralized server 11. The decentralized server 11 is designed as a data cloud or an internet server, for example. The decentralized server 11 advantageously provides an ontology ON to the control device SE. The control device SE is connected to the decentralized server 11 via a technical data link 13. The technical data link may be formed by a mobile radio communications network according to the 4G or 5G standard, or the 6G standard in the future.

The control device SE may advantageously access the ontology ON on the decentralized server 11. The ontology ON may advantageously be transferred or copied from the decentralized server 11 into the memory 9 of the vehicle 1, in particular into the memory 9 of the control device SE.

The technical data link 13 may also be formed by a cable, in particular a charging cable of an electrically driven vehicle. The technical data link 13 is particularly advantageously designed as a wireless technical data link 13, for example as WLAN or as a mobile radio communications network. The decentralized server 11 may thus advantageously communicate with a charging station, and with the aid of the charging station, provide the data for the memory 9 of the vehicle 1 or of the control device SE.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to control a vehicle, the vehicle comprising at least one sensor and at least one actuator, a control device, and a processing unit, the method comprising:
providing, via the at least one sensor, sensor values to the control device;
providing, via an input, an input signal to the control device;
providing, via the control device, at least one output signal to the actuator, the output signal being determined and provided based on the input signal and the at least one sensor signal, taking an ontology into account, the ontology being based on traffic regulations; and
determining, based on the ontology, whether the output signal is provided to an actuator or to which actuator the output signal is provided.

2. The method according to claim 1, wherein the ontology is stored in a memory in the vehicle.

3. The method according to claim 1, wherein the ontology is stored, at least in part, on a decentralized server, the control device being at least temporarily data-linked to the decentralized server.

4. The method according to claim 1, wherein the ontology includes the traffic regulations.

5. The method according to claim 4, wherein the ontology includes the traffic regulations of a particular region, a country, or a state, and wherein a selection of the traffic regulations takes place based on the particular location of the vehicle in the particular region.

6. The method according to claim 1, wherein it is decided, based on the ontology, whether or not the particular actuator carries out an action by use of the control device.

7. The method according to claim 1, wherein it is decided, based on the ontology, whether an output signal for a first actuator and/or an output signal for a second actuator is provided, based on an input signal.

8. The method according to claim 1, wherein a sensor is designed to provide GPS data to the control device.

9. The method according to claim 1, wherein the ontology is present in the form of a decision logic or a formal language, or a UML code.

10. A control device to control a vehicle, the control device comprising:
at least one input for at least one sensor signal of a sensor;
at least one input for at least one input signal of an input device;
at least one output for at least one output signal for an actuator; and
optionally a processing unit,
wherein the control device, in particular with the aid of a processing unit, is designed to check the input signal based on an ontology, the check being provided based on at least one sensor signal, the control device being provided to supply an output signal to the particular actuator, and
wherein the output signal is supplied based on the check of the input signal using the ontology and taking into account the at least one sensor signal.

11. The control device according to claim 10, wherein the ontology includes or is based on traffic regulations or traffic laws.

12. The control device according to claim 10, wherein the processing unit includes a memory, the memory storing the ontology, at least in part.

13. The control device according to claim 10 further comprising a technical data link to an external server, and wherein the control device or the external server is configured to provide an ontology to the processing unit.

14. A computer program product for installation and execution on a processing unit, wherein the computer program product is configured to carry out the method according to claim 1.

15. A vehicle comprising the control device according to claim 10.

16. The method according to claim 1, wherein the vehicle is a motor vehicle or a rail vehicle.
